(19) United States
(12) Patent Application Publication
(10) Pub. No.: US 2020/0115524 A1
(43) Pub. Date: Apr. 16, 2020

(54) CITRATE ESTER-POLYVINYL CHLORIDE COMPOSITIONS AND THEIR USE AS HEAT STABLE INSULATORS

(71) Applicant: Eastman Chemical Company, Kingsport, TN (US)

(72) Inventors: Zhenpeng Li, Piney Flats, TN (US); Eric Jon Moskala, Kingsport, TN (US)

(73) Assignee: Eastman Chemical Company, Kingsport, TN (US)

(21) Appl. No.: 16/598,184

(22) Filed: Oct. 10, 2019

Related U.S. Application Data
(60) Provisional application No. 62/744,694, filed on Oct. 12, 2018.

(51) Int. Cl. C08K 5/12; C08K 5/11; C08K 5/13; H01B 3/44; H01B 3/42

(52) U.S. Cl. CPC C08K 5/12; C08K 5/11; H01B 3/421; H01B 3/443; C08K 5/13

(57) ABSTRACT

The present application discloses a composition comprising: (1) a polyvinyl chloride polymer; (2) a plasticizer according to formula I:

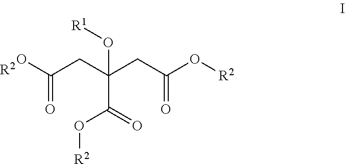

wherein R¹, and R² are described herein. The composition when formed into insulation layers for wire and cable insulation provides excellent heat stability (e.g., tensile strength and elongation at break retention). The present application further provides insulation layers formed from the composition of the present invention. The present application further provides cables that include a conductor and an insulation layer surrounding at least some of the conductor, the insulation layer being formed from the compositions of the present invention.

### BACKGROUND OF THE INVENTION

Plasticizer selection for electrical wire insulation is dependent upon the performance specifications of the insulation material and the jacketing or conductive covering. Performance specifications and tests such as accelerated aging tests, and the like, are well known in the art and are described by Underwriters Laboratory methods such as UL 83. For example, UL 83 specifies that conductive insulation with the 105° C. rating must retain minimum tensile properties after being aged for 7 days at 136° C.

The typical class of plasticizer used for 90° C. or 105° C. rating for conductive insulation is the trimellitate ester plasticizer class. Trimellitate esters are used as plasticizers where greater permanence is required. The permanence is achieved because of low migration and low volatility of the trimellitate esters. Examples of trimellitate esters used in the art are tri-2-ethylhexyl trimellitate (“TOTM”) and triisononyl trimellitate (“TINTM”). Although the trimellitate esters provide good performance, they are typically more costly. Additionally, trimellitate esters are more difficult to be processed in PVC formulations as compared to lower molecular weight plasticizers. The trimellitate ester PVC formulations also have high dry times.

### SUMMARY OF THE INVENTION

Applicants have provided a low cost, high performance citrate ester-based PVC formulation system exhibiting higher tensile strength retention and lower dry times as compared to trimellitate esters such as TOTM and TINTM while also exhibiting excellent compatibility with PVC.

The present application discloses a composition comprising:

(1) a polyvinyl chloride (PVC) polymer;

(2) a plasticizer according to formula I:

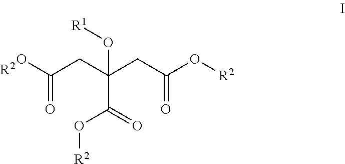

wherein:

R¹ is hydrogen or (C₁₋₆)alkyl-CO—; and

each R² is independently —(C₂₋₆)alkylene-O—(C₁₋₆)alkyl.

The present application also discloses an insulation layer formed from the composition; and a cable comprising a conductor and an insulation layer formed from the composition.

### DETAILED DESCRIPTION OF THE INVENTION

### Definitions

As used herein, the terms “a,” “an,” and “the” mean one or more.

“Stabilizer” means any additive added to a formulation that can prevent that helps to prevent the formulation from degrading. Classes of stabilizers include antioxidants, light stabilizers, acid scavengers, heat stabilizers, flame retardants, and biocides.

“Antioxidants” are chemicals used to interrupt degradation processes during the processing of materials. Antioxidants are classified into several classes, including primary antioxidant, and secondary antioxidant.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include Cyanox™ 1790, 2246, and 425; Topanol® CA (4-[4,4-bis(5-tert-butyl-4-hydroxy-2-methylphenyl)butan-2-yl]-2-tert-butyl-5-methylphenol), Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44625, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330PW, 2590 PW, and 3114 FF; and ADK Stab AO-20, AO-30, AO-40, AO-50, AO-60, AO-80, and AO-330.

“Phenolic antioxidants” are primary antioxidants having at least one phenolic moiety. Non-limiting examples include Cyanox 1790, Cyanox 2246, Cyanox 425, Ethanox 330, Irganox 1330, Irganox 245, Irganox 259, Irganox 1010, Irganox 1035, Irganox 1076, Irganox 1098, Irganox 1425, Irganox 3114, and Topanol CA.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, and S-9228; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

“Acid scavengers” are additives that neutralize acids formed during the processing of polymers. Examples of acid scavengers include Hycite 713; Kisuma DHT-4A, DHT-4V, DHT-4A-2, DHT-4C, ZHT-4V, and KW2200; Brueggemann Chemical Zinc Carbonate RAC; Sipax™ AC-207; calcium stearate; Baerlocher GL 34, RSN, GP, and LA Veg; Licomont CAV 102; FACl Calcium Stearate DW, PLC, SP, and WLC; Hangzhou Hitech Fine Chemical: CAST, and ZnST; Songstab™ SC-110, SC-120, SC-130, SM-310, and SZ-210; Sun Ace SAK-CS, SAK-DSC, SAK-DMS, SAK-DZS, and SAK-KS; US Zinc Oxide 201, 205 HAS, 205H, 210, and 210E; Drapex™ 4.4, 6.8, 39, 391, 392, and 392S; Vikoflex™ 4050, 5075, 7170, 7190, 7040, 9010, 9040, and 9080; Joncryl™ ADR 4468, and ADR 4400; Adeka CIZER D-32; Epon™ 1001F, 1002F, and 1007F; Aralidite™ ECN 1299, 1273, 1280, 1299, and 9511; Dynamar RC 5251Q; and Nexamite PBO.

A “salt stabilizer” can be incorporated into the composition to stabilize the composition during processing. The cation component of the salt stabilizer is chosen from aluminum, calcium, magnesium, copper, cerium, antimony, nickel, cobalt, manganese, barium, strontium, zinc, zirconium, tin, cadmium, chromium and iron cations; and the anion component of the salt stabilizer is an (C₆₋₂₀)alicyclic carboxylic acid, a (C₂₋₂₀)alkyl carboxylic acid, or a (C₆₋₂₀)alkenyl carboxylic acid. Examples of the (C₆₋₂₀)alicyclic carboxylic acid, the (C₆₋₂₀)alkyl carboxylic acid, or the (C₆₋₂₀)alkenyl carboxylic acid include naphthenic acid, abietic acid, cyclohexane carboxylic acid, cyclohexane propionic acid, 3-methyl-cyclopentyl acetic acid, 4-methylcyclohexane carboxylic acid, 2,2,6-trimethylcyclohexane carboxylic acid, 2,3-dimethylcyclopentyl acetic acid, 2-methylcyclopentyl propionic acid, palmitic acid, stearic acid, oleic acid, lauric acid, and the like. Examples of the salt stabilizers include strontium naphthenate, copper naphthenate, calcium naphthenate, zinc naphthenate, magnesium naphthenate, copper abietate, magnesium abietate, titanium acetate, titanium propionate, titanium butyrate, antimony acetate, antimony propionate, antimony butyrate, zinc acetate, zinc propionate, zinc butyrate, tin acetate, tin propionate, tin butyrate, 2-ethylhexylamine, bis(2-ethylhexyl)amine, tetrabutyl phosphonium bromide, dodecyldimenylamine, N,N-dimentylbenzylamine, tetramethyl guanidine, benzyltimethyl ammonium hydroxide, tetrabutyl ammonium hydroxide, 2-ethylimidazole, DBU/2-ethylheaxnoic acid, aluminum acetylacetonate, aluminate lactate, bismuth octoate, calcium octoate, cerium naphthenate, chromium(III) 2-ethylhexanoate, cobalt octoate, copper II acetylacetonate, Iron (III) acetylacetonate, manganese naphthenate, nickel acetylacetonate, stannous octoate, zinc acetate, zinc acetylacetonate, zinc octoate, zirconium octoate, and the like.

“Flame retardant” are materials that increase ignition time, reduce flame spreading and rate of burning. The flame retardant should have a high decomposition temperature, low volatility, a minimum effect on thermal and mechanical properties and good resistance to light and ultra-violet radiation. Examples of flame retardants that may be used include halogen containing compounds and phosphorous containing organic compounds such as triaryl, trialkyl or alkyl diaryl phosphate esters. Other materials that may be used include chloroparaffins, aluminum trihydrate, antimony oxides, or zinc borate.

“Fillers” are materials added to formulations or compositions primarily to reduce cost, increase the output of dry blending, increase electrical resistance, increase resistance to ultra-violet light, increase hardness, provide improved heat transmission, and to increase the resistance of heat deformation. Fillers can also impact anti-blocking or anti-slip performance of the compositions. Nonlimiting examples of fillers included calcium carbonate, clays, silica, dolomite, bauxite, titanium dioxide. The particular particle size distribution and average surface area of the filler will be chosen according to the properties it is desired to impart, as would be apparent to one of skill in the art.

“Processing aids” are chemicals that reduce the adhesion of the compositions with machinery surfaces during processing. The lubricants also affect the frictional properties between the polymer resin particles during processing. Nonlimiting examples of lubricants include stearic acid, metal stearates, waxes, silicon oil, mineral oil, and synthetic oils.

As used herein the term “chosen from” when used with “and” or “or” have the following meanings: A variable chosen from A, B and C means that the variable can be A alone, B alone, or C alone. A variable A, B, or C means for example that the variable can be A alone, B alone, C alone, A and B in combination, A and C in combination, B and C in combination, or A, B, and C in combination.

“Alkyl” groups suitable for use herein can be straight, branched, or cyclic, and can be saturated or unsaturated. Alkyl groups suitable for use herein include any (C₁₋₂₀), (C₁₋₁₂), (C₁₋₅), or (C₁₋₃) alkyl groups. In various embodiments, the alkyl can be a C₁₋₅ straight chain alkyl group. In still other embodiments, the alkyl can be a C₁₋₃ straight chain alkyl group. Specific examples of suitable alkyl groups include, but are not limited to, methyl, ethyl, n-propyl, isopropyl, n-butyl, isobutyl, sec-butyl, tert-butyl, pentyl, hexyl, octyl, decyl, dodecyl, cyclopentyl, and cyclohexyl groups. “Alkylene” is a bivalent alkyl group.

“ASTM” designates an ASTM International Test Method. “ASTM D3291-11” means ASTM method D3291-11(Reapproved 2016). “ASTM D2396-94” means ASTM method D2396-94 (Reapproved 2012). “ASTM D 412” means ASTM method D 412 (As updated 2016). “ASTM 2240-15” means ASTM method 2240-15 (As updated 2015).

“UL” designates an Underwrites Laboratories Inc. Standard. “UL 2556” designates the Jul. 19, 2007 version of the UL Standard for Safety for and Cable Test Methods. “UL 83” designates the Feb. 15, 2008 version of the UL Standard for thermoplastic-insulated wires and cables.

Citrate esters prepared from condensation of citric acid with alkyl-started oligo-alkylene alcohols and alkyl-carboxylic acid derivatives have been shown to display unexpected advantages of lower viscosity than certain trimellitate (e.g., TOTM, TINTM) based plasticizers typically used for heat stable insulator applications. The citrate esters disclosed in the current application when used to prepare PVC-based insulators have improved initial tensile strength, improved tensile strength retention, improved initial tensile strength, and improved drying time as compared to trimellitate-PVC based insulators, while maintaining acceptable compatibility with PVC resins.

In one embodiment, R¹ is (C₁₋₆)alkyl-CO—. In one class of this embodiment, R¹ is acetyl, propionyl, or butyryl. In one class of this embodiment, R¹ is acetyl, propionyl, butyryl, or isobutyryl. In one subclass of this class, R¹ is acetyl or propionyl. In one subclass of this class, R¹ is acetyl. In one subclass of this class, R¹ is propionyl, isobutyryl or butyryl. In one subclass of this class, R¹ is propionyl or butyryl. In one subclass of this class, R¹ is propionyl or isobutyryl. In one subclass of this class, R¹ is acetyl. In one subclass of this class, R¹ is propionyl. In one subclass of this class, R¹ is butyryl. In one subclass of this class, R¹ is isobutyryl or butyryl.

In one embodiment, R¹ is acetyl, propionyl, butyryl, or isobutyryl; and each R² is independently —(C₂₋₃)alkylene-O—(C₁₋₆)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl and each R² is independently

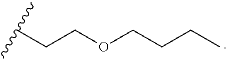 [SMILES: *CCOCCCC]

In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl; and each R² is independently —(C₂₋₃)alkylene-O—(C₁₋₆)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl or propionyl; and each R² is independently —(C₂₋₃)alkylene-O—(C₁₋₆)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl or propionyl; and each R² is independently —(C₂)alkylene-O—(C₁₋₆)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl; and each R² is independently —(C₂)alkylene-O—(C₁₋₆)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl or propionyl; and each R² is independently —(C₂)alkylene-O—(C₁₋₄)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl; and each R² is independently —(C₂)alkylene-O—(C₁₋₄)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl or propionyl; and each R² is independently —(C₂)alkylene-O—(C₃₋₅)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl; and each R² is independently —(C₂)alkylene-O—(C₃₋₅)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl or propionyl; and each R² is independently —(C₂₋₃)alkylene-O—(C₃₋₅)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl; and each R² is independently —(C₂₋₃)alkylene-O—(C₃₋₅)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, R¹ is acetyl or propionyl; and each R² is independently —(C₂₋₃)alkylene-O—(C₁₋₆)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one embodiment, each R² is independently

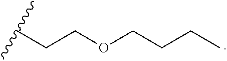 [SMILES: *CCOCCCC]

In one subclass of this class, the plasticizer is present from about 35 to 55 phr relative to the sum total of the PVC polymer. In one subclass of this class, the plasticizer is present from about 40 to 50 phr relative to the sum total of the PVC polymer.

In one embodiment, R¹ is propionyl; and each R² is independently —(C₂₋₃)alkylene-O—(C₁₋₆)alkyl. In one class of this embodiment, the plasticizer is present from about 35 to 55 phr relative to the sum total of the PVC polymer. In one class of this embodiment, the plasticizer is present from about 40 to 50 phr relative to the sum total of the PVC polymer.

In one class of this embodiment, each R² is independently —(C₂₋₃)alkylene-O—(C₄₋₆)alkyl. In one subclass of this class, the plasticizer is present from about 35 to 55 phr relative to the sum total of the PVC polymer. In one subclass of this class, the plasticizer is present from about 40 to 50 phr relative to the sum total of the PVC polymer.

In one class of this embodiment, each R² is independently —(C₂₋₃)alkylene-O—(C₃₋₅)alkyl. In one subclass of this class, the plasticizer is present from about 35 to 55 phr relative to the sum total of the PVC polymer. In one subclass of this class, the plasticizer is present from about 40 to 50 phr relative to the sum total of the PVC polymer.

In one class of this embodiment, each R² is independently

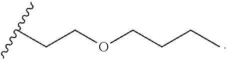 [SMILES: *CCOCCCC]

In one subclass of this class, the plasticizer is present from about 35 to 55 phr relative to the sum total of the PVC polymer. In one subclass of this class, the plasticizer is present from about 40 to 50 phr relative to the sum total of the PVC polymer.

In one embodiment, R¹ is butyryl; and each R² is independently —(C₂₋₃)alkylene-O—(C₁₋₆)alkyl. In one class of this embodiment, each R² is independently —(C₂₋₃)alkylene-O—(C₃₋₅)alkyl. In one class of this embodiment, each R² is independently —(C₂₋₄)alkylene-O—(C₃₋₅)alkyl. In one class of this embodiment, each R² is independently —(C₂₋₃)alkylene-O—(C₃₋₅)alkyl. In one class of this embodiment, each R² is independently —(C₂₋₃)alkylene-O—(C₄₋₆)alkyl. In one class of this embodiment, each R² is independently

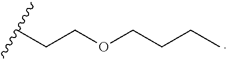 [SMILES: *CCOCCCC]

In one embodiment, R¹ is isobutyryl; and each R² is independently —(C₂₋₃)alkylene-O—(C₁₋₆)alkyl. In one class of this embodiment, each R² is independently —(C₂₋₃)alkylene-O—(C₃₋₅)alkyl. In one class of this embodiment, each R² is independently —(C₂₋₄)alkylene-O—(C₃₋₅)alkyl. In one class of this embodiment, each R² is independently —(C₂₋₃)alkylene-O—(C₃₋₅)alkyl. In one class of this embodiment, each R² is independently —(C₂₋₃)alkylene-O—(C₄₋₆)alkyl. In one class of this embodiment, each R² is independently

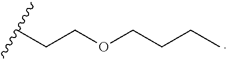 [SMILES: *CCOCCCC]

In one embodiment, each R² is independently —(C₂₋₃)alkylene-O—(C₁₋₆)alkyl.

In one embodiment, each R² is independently

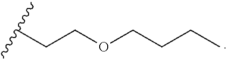 [SMILES: *CCOCCCC]

In one embodiment, the compound according to formula I is

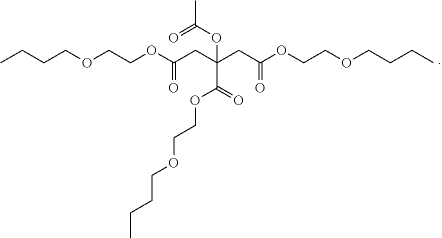 [SMILES: CCCCOCCOC(=O)CC(CC(=O)OCCOCCCC)(OC(C)=O)C(=O)OCCOCCCC]

In one embodiment, the plasticizer is present from about 35 to 55 phr relative to the sum total of the PVC polymer. In one embodiment, the plasticizer is present from about 40 to 50 phr relative to the sum total of the PVC polymer.

In one embodiment, the composition further comprises other components chosen from a filler, a flame retardant, a stabilizer, a pigment, a processing aid, another plasticizer, or combinations. The composition can also include other additives known to one of skill in the art. The choice of the additive will be chosen according to the desired properties needed for the composition.

In one embodiment, the composition further comprises a primary antioxidant. In one class of this embodiment, the primary antioxidant is present from 0.05 to 0.3 phr relative to the sum total of the PVC polymer. In one subclass of this class, the primary antioxidant is a phenolic antioxidant. In one sub-subclass of this subclass, the phenolic antioxidant is chosen from tris(4-tert-butyl-3-hydroxy-2,6-dimethylbenzyl) isocyanurate (e.g., Cyanox 1790); 2,2′-methylenebis(4-methyl-6-tert-butylphenol) (e.g., Cyanox 2246); 2,2′-methylenebis(4-ethyl-6-tert-butylphenol) (e.g., Cyanox 425); 1,3,5-trimethyl-2,4,6-tris(3,5-di-tert-butyl-4-hydroxybenzyl) benzene (e.g., Ethanox 330); 3,3′,3′,5,5′,5′-hexa-tert-butyl-a,a′,a′-(mesitylene-2,4,6-triyl)tri-p-cresol (e.g., Irganox 1330); ethylene bis(oxyethylene) bis-(3-(5-tert-butyl-4-hydroxy-m-tolyl)propionate) (e.g., Irganox 245); hexamethylene bis[3-(3,5-di-tert-butyl-4-hydroxyphenyl) propionate] (e.g., Irganox 259); pentaerythritol tetrakis(3-(3,5-di-tert-butyl-4-hydroxyphenyl)propionate) (e.g., Irganox 1010); thiodiethylene bis[3-(3,5-di-tert-butyl-4-hydroxyphenyl)propionate] (e.g., Irganox 1035); octadecyl 3-(3,5-di-tert-butyl-4-hydroxyphenyl)propionate (e.g., Irganox 1076); N,N′-1,6-hexanediylbis[3,5-bis(1,1-dimethylethyl)-4-hydroxy-benzenepropanamide (e.g., Irganox 1098); phosphonic acid, [[3,5-bis(1,1-dimethylethyl)-4-hydroxyphenyl]methyl]-, monoethyl ester, calcium salt (2:1) (e.g., Irganox 1425); 1,3,5-tris(3,5-di-tert-butyl-4-hydroxybenzyl)-1,3,5-triazine2,4,6(1H,3H,5H)-trione (e.g., Irganox 3114); or 1,1,3-tris(2-methyl-4-hydroxy-5-tert-butylphenyl)butane (e.g., Topanol CA). In one sub-sub-subclass of this sub-subclass, the phenolic antioxidant is 1,1,3-tris(2-methyl-4-hydroxy-5-tert-butylphenyl)butane.

In one class of this embodiment, the filler is chosen from calcium carbonate, magnesium carbonate, silica, clay, mica, graphite, zinc oxide, titanium dioxide or combinations. In one subclass of this class, the filler is present in an amount up to 75 phr based on the 100 phr of PVC.

In one embodiment, when the composition is molded into 0.762 mm thick die C cut specimen and exposed a temperature of 136° C. for 168 hours, in an atmosphere of circulated air as tested according to UL 2556 has a tensile strength retention of at least 80%, as compared to that of an unexposed control of the same composition and shape, wherein the tensile strength is determined according to ASTM D 412 at a 500 mm/min pulling rate.

In one class of this embodiment, the plasticizer of formula I has a viscosity of less than 50 centipoise as measured at 25° C. using an AR 2000 rotational rheometer using a 40 mm aluminum parallel plate.

In one class of this embodiment, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 3.5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one embodiment, when the composition is molded into 0.762 mm thick die C cut specimen and exposed a temperature of 136° C. for 168 hours, in an atmosphere of circulated air as tested according to UL 2556, has a tensile strength retention of at least 92%, as compared to that of an unexposed control of the same composition and shape, wherein the tensile strength is determined according to ASTM D 412 at a 500 mm/min pulling rate. In one class of this embodiment, the plasticizer of formula I has a viscosity of less than 50 centipoise as measured at 25° C. using an AR 2000 rotational rheometer using a 40 mm aluminum parallel plate.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 3.5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one embodiment, when the composition is molded into 0.762 mm thick die C cut specimen and exposed a temperature of 136° C. for 168 hours, in an atmosphere of circulated air as tested according to UL 2556, has a tensile strength retention of at least 93%, as compared to that of an unexposed control of the same composition and shape, wherein the tensile strength is determined according to ASTM D 412 at a 500 mm/min pulling rate. In one class of this embodiment, the plasticizer of formula I has a viscosity of less than 50 centipoise as measured at 25° C. using an AR 2000 rotational rheometer using a 40 mm aluminum parallel plate.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 3.5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one embodiment, when the composition is molded into 0.762 mm thick die C cut specimen and exposed a temperature of 136° C. for 168 hours, in an atmosphere of circulated air as tested according to UL 2556, has a tensile strength retention of at least 94%, as compared to that of an unexposed control of the same composition and shape, wherein the tensile strength is determined according to ASTM D 412 at a 500 mm/min pulling rate. In one class of this embodiment, the plasticizer of formula I has a viscosity of less than 50 centipoise as measured at 25° C. using an AR 2000 rotational rheometer using a 40 mm aluminum parallel plate.

In one class of this embodiment, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 3.5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one embodiment, when the composition is molded into 0.762 mm thick die C cut specimen and exposed a temperature of 136° C. for 168 hours, in an atmosphere of circulated air as tested according to UL 2556, has a tensile strength retention of at least 95%, as compared to that of an unexposed control of the same composition and shape, wherein the tensile strength is determined according to ASTM D 412 at a 500 mm/min pulling rate. In one class of this embodiment, the plasticizer of formula I has a viscosity of less than 50 centipoise as measured at 25° C. using an AR 2000 rotational rheometer using a 40 mm aluminum parallel plate.

In one class of this embodiment, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 3.5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one embodiment, when the composition is molded into 0.762 mm thick die C cut specimen and exposed a temperature of 136° C. for 168 hours, in an atmosphere of circulated air as tested according to UL 2556, has a tensile strength retention of at least 96%, as compared to that of an unexposed control of the same composition and shape, wherein the tensile strength is determined according to ASTM D 412 at a 500 mm/min pulling rate. In one class of this embodiment, the plasticizer of formula I has a viscosity of less than 50 centipoise as measured at 25° C. using an AR 2000 rotational rheometer using a 40 mm aluminum parallel plate.

In one class of this embodiment, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one class of this embodiment, the composition has a dry time of less than 3.5 min as measured according to ASTM 2396-94.

In one subclass of this class, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at 25° C. using an AR 2000 rotational rheometer using a 40 mm aluminum parallel plate.

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one subclass of this class, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one sub-subclass of this subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days.

In one sub-subclass of this subclass, the plasticizer of formula I has a viscosity of less than 50 centipoise as measured at

In one sub-sub-subclass of this sub-subclass, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero after seven days. 25° C. using an AR 2000 rotational rheometer using a 40 mm aluminum parallel plate.

In one embodiment, the composition has a dry time of less than 5 min as measured according to ASTM 2396-94. In one embodiment, the composition has a dry time of less than 4.5 min as measured according to ASTM 2396-94. In one embodiment, the composition has a dry time of less than 4 min as measured according to ASTM 2396-94. In one embodiment, the composition has a dry time of less than 3.5 min as measured according to ASTM 2396-94.

In one embodiment, when the composition is molded into 0.762 mm thick die C cut specimen and exposed a temperature of 136° C. for 168 hours, in an atmosphere of circulated air as tested according to UL 2556, has an elongation at break retention of at least 70%, as compared to that of an unexposed control of the same composition and shape, wherein the tensile strength is determined according to ASTM D 412 at a 500 mm/min pulling rate.

In one embodiment, when the composition is molded into 0.762 mm thick die C cut specimen and exposed a temperature of 136° C. for 168 hours, in an atmosphere of circulated air as tested according to UL 2556, has an elongation at break retention of at least 75%, as compared to that of an unexposed control of the same composition and shape, wherein the tensile strength is determined according to ASTM D 412 at a 500 mm/min pulling rate.

In one embodiment, when the composition is molded into 0.762 mm thick die C cut specimen and exposed a temperature of 136° C. for 168 hours, in an atmosphere of circulated air as tested according to UL 2556, has an elongation at break retention of at least 77%, as compared to that of an unexposed control of the same composition and shape, wherein the tensile strength is determined according to ASTM D 412 at a 500 mm/min pulling rate.

In one embodiment, when the composition is molded into 0.762 mm thick die C cut specimen and exposed a temperature of 136° C. for 168 hours, in an atmosphere of circulated air as tested according to UL 2556, has an elongation at break retention of at least 80%, as compared to that of an unexposed control of the same composition and shape, wherein the tensile strength is determined according to ASTM D 412 at a 500 mm/min pulling rate.

In one embodiment, when the composition is molded into 0.762 mm thick die C cut specimen and exposed a temperature of 136° C. for 168 hours, in an atmosphere of circulated air as tested according to UL 2556, has an elongation at break retention of at least 85%, as compared to that of an unexposed control of the same composition and shape, wherein the tensile strength is determined according to ASTM D 412 at a 500 mm/min pulling rate.

In one embodiment, when the composition is molded into 0.762 mm thick die C cut specimen and exposed a temperature of 136° C. for 168 hours, in an atmosphere of circulated air as tested according to UL 2556, has an elongation at break retention of at least 90%, as compared to that of an unexposed control of the same composition and shape, wherein the tensile strength is determined according to ASTM D 412 at a 500 mm/min pulling rate.

In one embodiment, when the composition is molded into 0.762 mm thick die C cut specimen and exposed a temperature of 136° C. for 168 hours, in an atmosphere of circulated air as tested according to UL 2556, has an elongation at break retention of at least 95%, as compared to that of an unexposed control of the same composition and shape, wherein the tensile strength is determined according to ASTM D 412 at a 500 mm/min pulling rate.

In one embodiment, the plasticizer of formula I has a viscosity of less than 60 centipoise as measured at 25° C. using an AR 2000 rotational rheometer using a 40 mm aluminum parallel plate. In one embodiment, the plasticizer of formula I has a viscosity of less than 50 centipoise as measured at 25° C. using an AR 2000 rotational rheometer using a 40 mm aluminum parallel plate.

The present application discloses an insulation layer formed from any of the previously described compositions. In one embodiment, the insulation layer is formed from a composition comprising:
(1) a polyvinyl chloride (PVC) polymer;
(2) a plasticizer according to formula I:

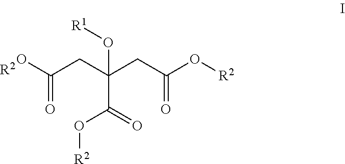

wherein:
R¹ is (C₁₋₆)alkyl-CO—; and
each R² is independently —(C₂₋₆)alkylene-O—(C₁₋₆)alkyl,
the plasticizer is present from 35 to 55 phr relative to the sum total of the PVC polymer.

In one class of this embodiment, R¹ is acetyl, propionyl, butyryl, or isobutyryl. In one subclass of this class, each R² is independently —(C₂₋₃)alkylene-O—(C₁₋₆)alkyl. In one subclass of this class, each R² is independently —(C₂₋₃)alkylene-O—(C₄₋₆)alkyl. In one subclass of this class, each R² is independently —(C₂₋₃)alkylene-O—(C₃₋₅)alkyl. In one subclass of this class, each R² is independently —(C₂)alkylene-O—(C₄₋₆)alkyl. In one subclass of this class, each R² is independently —(C₂)alkylene-O—(C₃₋₅)alkyl. In one subclass of this class, each R² is independently

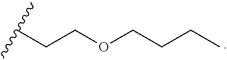 [SMILES: *CCOCCCC]

In one sub-subclass of this subclass, the composition further comprises 0.05 to 0.3 phr of a primary antioxidant relative to the sum total of the PVC polymer. In one sub-sub-subclass of this sub-subclass, the primary antioxidant is a phenolic antioxidant.

In one class of this embodiment, R¹ is acetyl or propionyl. In one subclass of this class, each R² is independently —(C₂₋₃)alkylene-O—(C₁₋₆)alkyl. In one subclass of this class, each R² is independently —(C₂₋₃)alkylene-O—(C₄₋₆)alkyl. In one subclass of this class, each R² is independently —(C₂₋₃)alkylene-O—(C₃₋₅)alkyl. In one subclass of this class, each R² is independently —(C₂)alkylene-O—(C₄₋₆)alkyl. In one subclass of this class, each R² is independently —(C₂)alkylene-O—(C₃₋₅)alkyl. In one subclass of this class, each R² is independently

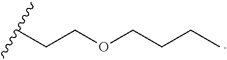 [SMILES: *CCOCCCC]

In one sub-subclass of this subclass, the composition further comprises 0.05 to 0.3 phr of a primary antioxidant relative to the sum total of the PVC polymer. In one sub-sub-subclass of this sub-subclass, the primary antioxidant is a phenolic antioxidant.

In one class of this embodiment, R¹ is acetyl. In one subclass of this class, each R² is independently —(C₂₋₃)alkylene-O—(C₁₋₆)alkyl. In one subclass of this class, each R² is independently —(C₂₋₃)alkylene-O—(C₄₋₆)alkyl. In one subclass of this class, each R² is independently —(C₂₋₃)alkylene-O—(C₃₋₅)alkyl. In one subclass of this class, each R² is independently —(C₂)alkylene-O—(C₄₋₆)alkyl. In one subclass of this class, each R² is independently —(C₂)alkylene-O—(C₃₋₅)alkyl. In one subclass of this class, each R² is independently

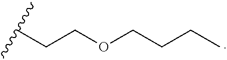 [SMILES: *CCOCCCC]

In one sub-subclass of this subclass, the composition further comprises 0.05 to 0.3 phr of a primary antioxidant relative to the sum total of the PVC polymer. In one sub-sub-subclass of this sub-subclass, the primary antioxidant is a phenolic antioxidant.

In one class of this embodiment, the composition further comprises 0.05 to 0.3 phr of a primary antioxidant relative to the sum total of the PVC polymer. In one subclass of this class, the primary antioxidant is a phenolic antioxidant. In one sub-subclass of this subclass, the phenolic antioxidant is chosen from tris(4-tert-butyl-3-hydroxy-2,6-dimethylbenzyl) isocyanurate (e.g., Cyanox 1790); 2,2′-methylenebis(4-methyl-6-tert-butylphenol) (e.g., Cyanox 2246); 2,2′-methylenebis(4-ethyl-6-tert-butylphenol) (e.g., Cyanox 425); 1,3,5-trimethyl-2,4,6-tris(3,5-di-tert-butyl-4-hydroxybenzyl) benzene (e.g., Ethanox 330); 3,3′,3′,5,5′,5′-hexa-tert-butyl-a,a′,a′-(mesitylene-2,4,6-triyl)tri-p-cresol (e.g., Irganox 1330); ethylene bis(oxyethylene) bis-(3-(5-tert-butyl-4-hydroxy-m-tolyl)propionate) (e.g., Irganox 245); hexamethylene bis[3-(3,5-di-tert-butyl-4-hydroxyphenyl) propionate] (e.g., Irganox 259); pentaerythritol tetrakis(3-(3,5-di-tert-butyl-4-hydroxyphenyl)propionate) (e.g., Irganox 1010); thiodiethylene bis[3-(3,5-di-tert-butyl-4-hydroxyphenyl)propionate] (e.g., Irganox 1035); octadecyl 3-(3,5-di-tert-butyl-4-hydroxyphenyl)propionate (e.g., Irganox 1076); N,N′-1,6-hexanediylbis[3,5-bis(1,1-dimethylethyl)-4-hydroxy-benzenepropanamide (e.g., Irganox 1098); phosphonic acid, [[3,5-bis(1,1-dimethylethyl)-4-hydroxyphenyl]methyl]-, monoethyl ester, calcium salt (2:1) (e.g., Irganox 1425); 1,3,5-tris(3,5-di-tert-butyl-4-hydroxybenzyl)-1,3,5-triazine2,4,6(1H,3H,5H)-trione (e.g., Irganox 3114); or 1,1,3-tris(2-methyl-4-hydroxy-5-tert-butylphenyl)butane (e.g., Topanol CA). In one sub-sub-subclass of this sub-subclass, the phenolic antioxidant is 1,1,3-tris(2-methyl-4-hydroxy-5-tert-butylphenyl)butane.

The present application also discloses a cable comprising a conductor; and an insulation layer surrounding the conductor, the insulation layer formed from any of the previously described compositions.

In one embodiment, the insulation layer is formed from a composition comprising:
(1) a polyvinyl chloride (PVC) polymer;
(2) a plasticizer according to formula I:

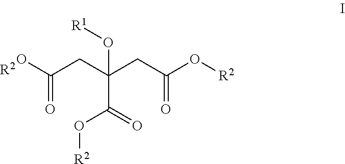

wherein:
R¹ is (C₁₋₆)alkyl-CO—; and
each R² is independently —(C₂₋₆)alkylene-O—(C₁₋₆)alkyl,
the plasticizer is present from 35 to 55 phr relative to the sum total of the PVC polymer.

In one class of this embodiment, R¹ is acetyl, propionyl, butyryl, or isobutyryl. In one subclass of this class, each R² is independently —(C₂₋₃)alkylene-O—(C₁₋₆)alkyl. In one subclass of this class, each R² is independently —(C₂₋₃)alkylene-O—(C₄₋₆)alkyl. In one subclass of this class, each R² is independently —(C₂₋₃)alkylene-O—(C₃₋₅)alkyl. In one subclass of this class, each R² is independently —(C₂)alkylene-O—(C₄₋₆)alkyl. In one subclass of this class, each R² is independently —(C₂)alkylene-O—(C₃₋₅)alkyl. In one subclass of this class, each R² is independently

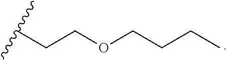 [SMILES: *CCOCCCC]

In one sub-subclass of this subclass, the composition further comprises 0.05 to 0.3 phr of a primary antioxidant relative to the sum total of the PVC polymer. In one sub-sub-subclass of this sub-subclass, the primary antioxidant is a phenolic antioxidant.

In one class of this embodiment, R¹ is acetyl or propionyl. In one subclass of this class, each R² is independently —(C₂₋₃)alkylene-O—(C₁₋₆)alkyl. In one subclass of this class, each R² is independently —(C₂₋₃)alkylene-O—(C₄₋₆)alkyl. In one subclass of this class, each R² is independently —(C₂₋₃)alkylene-O—(C₃₋₅)alkyl. In one subclass of this class, each R² is independently —(C₂)alkylene-O—(C₄₋₆)alkyl. In one subclass of this class, each R² is independently —(C₂)alkylene-O—(C₃₋₅)alkyl. In one subclass of this class, each R² is independently

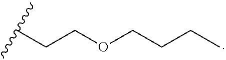 [SMILES: *CCOCCCC]

In one sub-subclass of this subclass, the composition further comprises 0.05 to 0.3 phr of a primary antioxidant relative to the sum total of the PVC polymer. In one sub-sub-subclass of this sub-subclass, the primary antioxidant is a phenolic antioxidant.

In one class of this embodiment, R¹ is acetyl. In one subclass of this class, each R² is independently —(C₂₋₃)alkylene-O—(C₁₋₆)alkyl. In one subclass of this class, each R² is independently —(C₂₋₃)alkylene-O—(C₄₋₆)alkyl. In one subclass of this class, each R² is independently —(C₂₋₃)alkylene-O—(C₃₋₅)alkyl. In one subclass of this class, each R² is independently —(C₂)alkylene-O—(C₄₋₆)alkyl. In one subclass of this class, each R² is independently —(C₂)alkylene-O—(C₃₋₅)alkyl. In one subclass of this class, each R² is independently

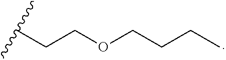 [SMILES: *CCOCCCC]

In one sub-subclass of this subclass, the composition further comprises 0.05 to 0.3 phr of a primary antioxidant relative to the sum total of the PVC polymer. In one sub-sub-subclass of this sub-subclass, the primary antioxidant is a phenolic antioxidant.

In one class of this embodiment, the composition further comprises 0.05 to 0.3 phr of a primary antioxidant relative to the sum total of the PVC polymer. In one subclass of this class, the primary antioxidant is a phenolic antioxidant. In one sub-subclass of this subclass, the phenolic antioxidant is chosen from tris(4-tert-butyl-3-hydroxy-2,6-dimethylbenzyl) isocyanurate (e.g., Cyanox 1790); 2,2′-methylenebis(4-methyl-6-tert-butylphenol) (e.g., Cyanox 2246); 2,2′-methylenebis(4-ethyl-6-tert-butylphenol) (e.g., Cyanox 425); 1,3,5-trimethyl-2,4,6-tris(3,5-di-tert-butyl-4-hydroxybenzyl) benzene (e.g., Ethanox 330); 3,3′,3′,5,5′,5′-hexa-tert-butyl-a,a′,a′-(mesitylene-2,4,6-triyl)tri-p-cresol (e.g., Irganox 1330); ethylene bis(oxyethylene) bis-(3-(5-tert-butyl-4-hydroxy-m-tolyl)propionate) (e.g., Irganox 245); hexamethylene bis[3-(3,5-di-tert-butyl-4-hydroxyphenyl) propionate] (e.g., Irganox 259); pentaerythritol tetrakis(3-(3,5-di-tert-butyl-4-hydroxyphenyl)propionate) (e.g., Irganox 1010); thiodiethylene bis[3-(3,5-di-tert-butyl-4-hydroxyphenyl)propionate] (e.g., Irganox 1035); octadecyl 3-(3,5-di-tert-butyl-4-hydroxyphenyl)propionate (e.g., Irganox 1076); N,N′-1,6-hexanediylbis[3,5-bis(1,1-dimethylethyl)-4-hydroxy-benzenepropanamide (e.g., Irganox 1098); phosphonic acid, [[3,5-bis(1,1-dimethylethyl)-4-hydroxyphenyl]methyl]-, monoethyl ester, calcium salt (2:1) (e.g., Irganox 1425); 1,3,5-tris(3,5-di-tert-butyl-4-hydroxybenzyl)-1,3,5-triazine2,4,6(1H,3H,5H)-trione (e.g., Irganox 3114); or 1,1,3-tris(2-methyl-4-hydroxy-5-tert-butylphenyl)butane (e.g., Topanol CA). In one sub-sub-subclass of this sub-subclass, the phenolic antioxidant is 1,1,3-tris(2-methyl-4-hydroxy-5-tert-butylphenyl)butane. The cables can be formed in a variety of configurations including as single-core cables, multi-core cables, tray cables, inter-locked armored cables, and continuously corrugated welded cable constructions. The conductors in such cables can be surrounded by one or more insulation layers and/or jacket layers. In one embodiment, at least one of these insulation layers or jacket layers can be formed with the disclosed composition.

The conductor, or conductive element, of a cable, can generally include any suitable electrically conducting material. For example, a generally electrically conductive metal such as, for example, copper, aluminum, a copper alloy, an aluminum alloy (e.g. aluminum-zirconium alloy), or any other conductive metal can serve as the conductive material. As will be appreciated, the conductor can be solid, or can be twisted and braided from a plurality of smaller conductors. The conductor can be sized for specific purposes. For example, a conductor can range from a 1 kcmil conductor to a 1,500 kcmil conductor in certain embodiments, a 4 kcmil conductor to a 1,000 kcmil conductor in certain embodiments, a 50 kcmil conductor to a 500 kcmil conductor in certain embodiments, or a 100 kcmil conductor to a 500 kcmil conductor in certain embodiments. The voltage class of a cable including such conductors can also be selected. For example, a cable including a 1 kcmil conductor to a 1,500 kcmil conductor and an insulating layer formed from a suitable thermoset composition can have a voltage class ranging from about 1 kV to about 150 kV in certain embodiments, or a voltage class ranging from about 2 kV to about 65 kV in certain embodiments. In certain embodiments, a cable can also meet the medium voltage electrical properties of ICEA test standard S-94-649-2004.

### Examples

### Abbreviations

Ac₂O is acetic anhydride; AcOH is acetic acid; aq is aqueous; ° C. is degree Celsius; g is grams; h is hour(s); kcmil is kilo circular mil; kV is kilovolt; L is liter; min is minute; mL is milliliter; mm is millimeter; mmol is millimole; mol is mole; MSA is methanesulfonic acid; pTsOH is p-toluenesulfonic acid; phr is parts per hundred resin; PVC is polyvinyl chloride; rt is room temperature; TLC is thin layer chromatography; wt % is weight percent.

### Preparation of Formulations

The formulations were prepared a by mixing the appropriate amount of components as specified in Table 2 in a Flackteck Speedmixer at 2000 RPM for 5 mins.

### Preparations of Test Plaques

Wire and cable insulation test films were prepared by mixing the components in a Flacktek Speedmixer. The formulations were then fused on a two-roll mill at 190° C. and subsequently pressed into 0.762 mm thick plaques using die C on a Carver press.

### Viscosity Measurement

Plasticizer zero shear viscosity was measured on an AR 2000 rotational rheometer. Viscosity measurements were taken at 25° C. with a 40 mm aluminum parallel plate.

### Tensile Strength Test

The tensile strength was determined according to ASTM D 412. The test specimens were cut with standard die C (0.762 mm thickness) specified in ASTM D 412. The samples were tested at 23° C. with 500 mm/min pulling rate.

The tensile strength retention values are determined by first measuring the tensile strength value for a specimen made before exposing the specimen according to UL 2556. Then a specimen is exposed to a temperature of 136° C. for 168 hours, in an atmosphere of circulated air as tested according to UL 2556. The tensile strength retention values are obtained by dividing the final values by the initial values and multiplying the quotient by 100.

### Elongation at Break Test

The elongation at break was determined according to ASTM D 412. The test specimens were cut with standard die C (0.762 mm thickness) specified in ASTM D 412. The samples were tested at 23° C. with 500 mm/min pulling rate.

The elongation at break retention values are determined by first measuring the elongation at break value for a specimen made before exposing the specimen according to UL 2556. Then a specimen is exposed to a temperature of 136° C. for 168 hours, in an atmosphere of circulated air as tested according to UL 2556. The elongation at break retention values are obtained by dividing the final values by the initial values and multiplying the quotient by 100.

### Sample Heat Aging

PVC samples were aged in an air circulated oven at specified temperatures and times as specified in UL 2556, clause 4.2.8.2.

### Shore A Hardness Test

The shore A hardness was measured according to ASTM 2240-15.

### Dry Time Test

The dry time was measured according to ASTM D2396-94 using a Torque Rheometer.

### Exudation (Compatibility)

Compatibility was determined using a loop spew test conducted in accordance with ASTM D3291-11. Exudation Grading of 0 to 3 after 7 days was recorded in accordance with the method.

The plasticizers used in this work are provided below.

### Eastman™ TOTM Plasticizer (Tris(2-Ethylhexyl) Benzene-1,2,4-tricarboxylate)

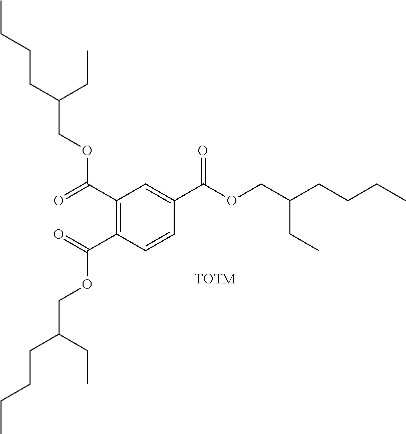

Eastman™ TOTM plasticizer was obtained from Eastman Chemical Company.

### Jayflex™ TINTM (Tris(isononyl) Benzene-1,2,4-tricarboxylate)

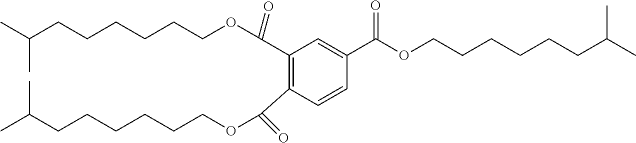 [SMILES: CC(C)CCCCCCOC(=O)c1ccc(C(=O)OCCCCCCC(C)C)c(C(=O)OCCCCCCC(C)C)c1]

Jayflex™ TINTM can be obtained from ExxonMobil.

### Benzoyl Tri-2-Butoxyethanol Citrate (BTDBC)

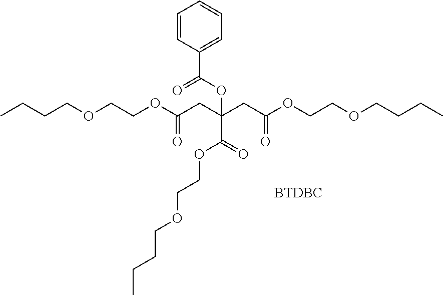

Tri-2-butoxyethanol Citrate (TEBC) (900 g, 2.5 mol) was added to a mixture of ZnCl (17 g) and KBr (29.8 g). To this mixture was added benzoyl chloride (456.6 g, 3.25 mol). This solution was heated to 60° C. for 4 hours and then allowed to stir overnight at rt. HCl gas evolved from the solution during the reaction and was quenched by passing nitrogen over the solution and into a container of dilute aqueous sodium hydroxide.

When the reaction was complete as determined by TLC, the solution was washed with 10% Na₂CO₃ (600 g) and brine (400 g); toluene (600 g) was added to enhance separation. The organic layer was then filtered and heated to 90° C. At temperature, 35 wt % H₂O₂ (20 g) was added. After 1 h at 90° C. the temperature was increased to 135° C. Volatiles were removed under vacuum (<5 mmHg). Further volatiles were removed by reducing temperature to 110° C. and applied subsurface nitrogen under vacuum for thirty min. Solution was then cooled to 90° C. and charged activated carbon (2 g) and stirred 45 min. Filtration through diatomaceous earth provided the title compound.

### Citrofol® AHII: Acetyl Tris(2-Ethylhexyl) Citrate (ATEC)

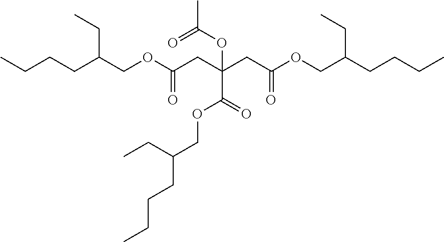 [SMILES: CCCCC(CC)COC(=O)CC(CC(=O)OCC(CC)CCCC)(OC(C)=O)C(=O)OCC(CC)CCCC]

Citrofol® AHII can be obtained from Jungbunzlauer.

### Tri-2-butoxyethanol Citrate (TEBC)

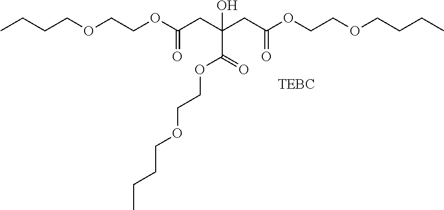 [SMILES: CCCCOCCOC(=O)CC(O)(CC(=O)OCCOCCCC)C(=O)OCCOCCCC]

To a flask was added citric acid (240.2 g, 1.25 mol), ethylene glycol monobutyl ether (590.9 g, 5 mol), toluene (100 g, 1.09 mol), p-toluenesulfonic acid (8.3 g, 0.044 mmol), and phosphinic acid (4.2 g, 0.064 mmol). The flask was equipped with a Dean-Stark decanter and slowly heated (155° C.) under a nitrogen atmosphere for 4.5 h and water (71.5 mL) was collected. The solution was stripped to (<3 mmHg) at 150° C. until approximately 115 mL of volatiles were removed. The solution was cooled to 80° C. and washed 5% of Na₂CO₃ (2×200 mL) and brine (200 mL). The solution was then treated with 35 wt % H₂O₂ (12 g) and held at 100° C. for one h. The solution was washed again with 5% Na₂CO₃ (100 mL) and brine (300 mL). The solution was concentrated under vacuum (<3 mmHg) at 80° C. Activated carbon was added to the concentrate and the mixture was stirred at 80° C. for 30 min before filtering through diatomaceous earth to provide the title compound.

### Acetyl Tri-2-Butoxyethanol Citrate (ATEBC)

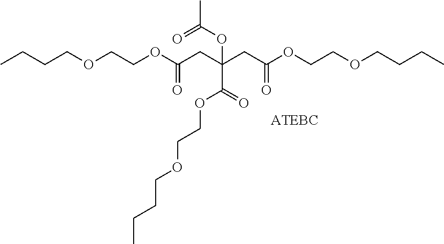 [SMILES: CCCCOCCOC(=O)CC(CC(=O)OCCOCCCC)(OC(C)=O)C(=O)OCCOCCCC]

A solution of 95:5 Ac₂O:AcOH (153 g, 1.425 mmol Ac₂O) was added slowly to TEBC (614 g, 1.15 mmol) while stirring at 80° C. After the addition was completed, the temperature was increased to 100° C. When the acetylation was complete, as determined by TLC, AcOH was removed under vacuum (<3 mmHg) at 100° C. until approximately acetic acid (74 mL) was collected. The solution was cooled to 80° C. and washed with 5% of sodium carbonate (2×200 mL) and brine (200 mL). The solution was then treated with 35 wt % H₂O₂ (35 g) and held at 100° C. for one h. The solution was washed again with 5% sodium carbonate (100 mL) and Brine (300 mL). The solution was concentrated under vacuum (<3 mmHg) at 80° C. Activated carbon was added to the concentrate and the mixture was stirred at 80° C. for 30 min before filtering through diatomaceous earth to provide the title compound.

### Tri-2-butoxyethanol Citrate (TDBC)

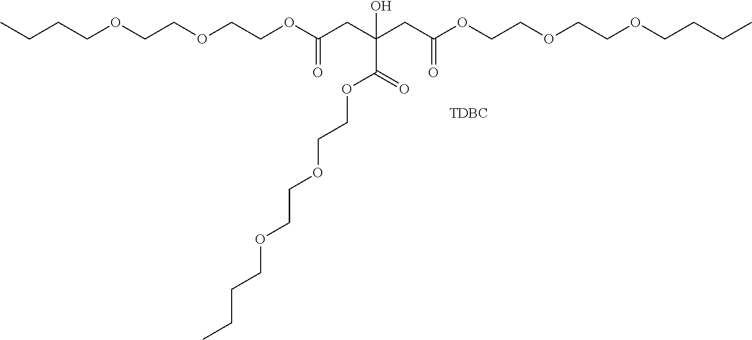

To a flask was added citric acid (960.6 g, 5 mol), diethylene glycol monobutyl ether (3244.6 g 20 mol), isooctane (80.7 g, 0.71 mol), and titanium tetraisopropoxide (4.2 g, 14.8 mmol). The flask was equipped with a Dean-Stark decanter and heated to reflux. The solution temperature was held between 135-137° C. and isooctane (10×225 g) was added throughout the course of the reaction to maintain an adequate solvent level. The reaction was heated (˜24 h) over the course of which water (226.8 g) was removed. The solvents were removed in vacuo (<5 mmHg) at 135° C. The resulting material was washed with 10 wt % aqueous Na₂CO₃ (2×400 g), deionized water (1×100 g, 1×200 g), and finally with a mixture of 4 wt % aq Na₂CO₃ (400 g) and brine (200 g). The material was filtered and volatiles removed at 100° C. in vacuo (<5 mmHg). The material was cooled to 80° C., and 35 wt % (15 g) was added to the material (8×5 g). Deionized water (100 g) and brine (200 g) was then added to the mixture and the aqueous layer was removed. The resulting mixture was washed again with brine (200 g, and the mixture was separated. The mixture dried with MgSO₄ (100 g) and heated to 70° C. before filtering through diatomaceous earth to give the title compound.

### Acetyl tri-2-Ethoxybutoxyethanol Citrate (ATDBC)

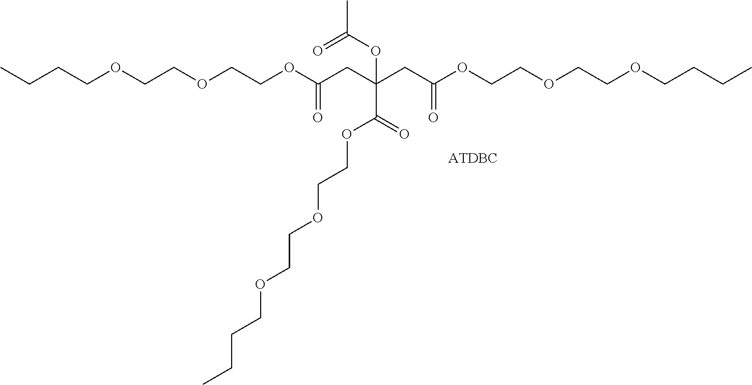

The TDBC (2.0 mol) was then charged to a flask and charged with pTSOH (4.5 g, 0.26 mol) and 95 wt % Ac₂O (294 g, 2.74 mol). The reaction mixture was stirred (60° C.) overnight. The reaction mixture was concentrated in vacuo (80° C., <5 mmHg). The concentrate was washed with 10 wt % Na₂CO₃ (400 g) and brine (5×200 g). The organic layer was filtered through diatomaceous earth. The resulting mixture was heated (80° C.) and 35 wt % H₂O₂ (48 g) followed by and additional amount of 35 wt % H₂O₂ (6 g). The resulting mixture was washed 10 wt % Na₂CO₃ (400 g) and brine (3×300 g). The resulting mixture was treated with activate carbon and the mixture was heated (80° C., 45 min). Then the MgSO₄ (100 g) was added to the mixture. The mixture as then filtered through diatomaceous earth to give the title compound.

The viscosity values for the plasticizers are provided in Table 1.

TABLE 1

| | | ATEBC/ | | | | | | |
|---|---|---|---|---|---|---|---|---|
| | ATEBC | TEBC | TDBC | ATDBC | TOTM | TINTM | BTDBC | ATEC |
| Viscosity | 49.3 | 48.3 | 48.6 | 49.1 | 192 | 300 | 52.1 | 73.7 |
| (cP) | | | | | | | | |

Table 2 provides the specific formulations prepared (Ex 1-10).

TABLE 2

| Components | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| PVC -Oxy 240 (phr) | 100 | 100 | 100 | 100 | 100 | 100 | 100 | 100 | 100 | 100 |
| Pz (phr) | ATEBC | ATEBC | ATEBC | ATEBC/ | TDBC | ATDBC | TOTM | TINTM | BTDBC | ATEC |
| | (47) | (40) | (40) | TEBC, 2:1 | (47) | (47) | (47) | (47) | (47) | (47) |
| | | | | (47) | | | | | | |
| Topanol CA (phr) | 0.14 | 0.14 | — | 0.14 | 0.14 | 0.14 | 0.14 | 0.14 | 0.14 | 0.14 |
| Calcined Clay (phr) | 12 | 12 | 12 | 12 | 12 | 12 | 12 | 12 | 12 | 12 |
| CaCO₂ (phr) | 8 | 8 | 8 | 8 | 8 | 8 | 8 | 8 | 8 | 8 |
| Naftosafe ™ | 5 | 5 | 5 | 5 | 5 | 5 | 5 | 5 | 5 | 5 |
| PKP 314 (phr) | | | | | | | | | | |
| Sb₂O₃ (phr) | 2.5 | 2.5 | 2.5 | 2.5 | 2.5 | 2.5 | 2.5 | 2.5 | 2.5 | 2.5 |

The dry times for Ex 1-2 and 5-8 are provided in Table 3.

TABLE 3.

| | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| Dry Time | 4.47 | 3.26 | n/a | n/a | 3.10 | 3.13 | 6.03 | 5.93 | 4.25 | 7.57 |
| (min) | | | | | | | | | | |

n/a = not tested

Table 4 provides the shore A hardness, tensile strength retention and elongation at break retention values for and Ex 1-10. The tensile strength retention for Ex 4-10 is from 89.0% and 96.8%. However, Ex 1-2 have a higher tensile strength retention that is from 98.6% to 98.7%. The elongation at break retention for compositions with TOTM and TINTM (E×7 and E×8) is 89.0% and 95.5% respectively. However, the compositions prepared with BTDBC (Ex 9) and ATEC (Ex 10) is 46.3% and 43.6%, respectively. Ex 4, 5 and 6 had 71.4%, 74.9%, and 77.4% elongation at break retention, respectively. On the other hand, Ex 1 and Ex 2, both prepared from ATEBC, have elongation at break retention of 77.2% and 82.2%, respectively. Ex 3 shows the effect of topanol CA (a phenolic antioxidant) on the elongation at break retention. Ex 3 does not contain topanol CA, and the elongation at break retention is significantly reduced, relative to Ex 1.

TABLE 4

| | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| Shore A Hardness | 92.0 | 95.9 | — | — | — | — | 95.7 | 96.4 | — | — |
| Initial Tensile | 23.2 | 21.9 | 22.9 | 21.4 | 22.1 | 21.7 | 19.9 | 19.1 | 20.7 | 22.1 |
| Strength (MPa) | | | | | | | | | | |
| Aged Tensile | 22.9 | 21.6 | 21.2 | 19.8 | 20.8 | 21.0 | 18.3 | 17.0 | 18.5 | 20.5 |
| Strength (MPa) | | | | | | | | | | |
| Tensile Strength | 98.7 | 98.6 | 92.6 | 92.6 | 94.1 | 96.8 | 92.0 | 89.0 | 89.4 | 92.8 |
| Retention (%) | | | | | | | | | | |
| Initial Elongation | 228 | 223 | 226 | 231 | 211 | 208 | 196 | 154 | 162 | 156 |
| at Break (%) | | | | | | | | | | |
| Aged Elongation | 176 | 152 | 124 | 165 | 158 | 161 | 175 | 147 | 75 | 68 |
| at Break (%) | | | | | | | | | | |
| Elongation at Break | 77.2 | 68.2 | 54.9 | 71.4 | 74.9 | 77.4 | 89.3 | 95.4 | 46.3 | 43.6 |
| Retention (%) | | | | | | | | | | |
| Exudation Grading | 0 | 0 | 0 | 0 | 3 | 3 | 0 | 0 | 3 | 2 |

Examples 1 and 2 demonstrate high Tensile Strength Retention as well as advantaged compatibility, demonstrated by an Exudation Grading of zero.

We claim:

1. A composition comprising:
(1) a polyvinyl chloride (PVC) polymer;
(2) a plasticizer according to formula I: 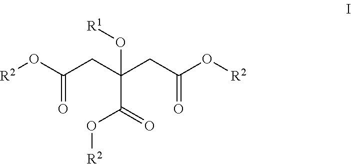
wherein:
R¹ is (C₁₋₆)alkyl-CO—; and
each R² is independently —(C₂₋₆)alkylene-O—(C₁₋₆)alkyl.

2. The composition of claim 1, wherein R¹ is acetyl, propionyl, butyryl, or isobutyryl.

3. The composition of claim 2, wherein each R² is independently —(C₂₋₃)alkylene-O—(C₁₋₆)alkyl.

4. The composition of claim 2, wherein each R² is independently —(C₂₋₃)alkylene-O—(C₃₋₅)alkyl.

5. The composition of claim 2, wherein each R² is independently

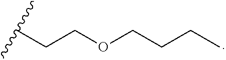 [SMILES: *CCOCCCC]

6. The composition of claim 1, wherein R¹ is acetyl or propionyl.

7. The composition of claim 6, wherein each R² is independently —(C₂₋₃)alkylene-O—(C₁₋₆)alkyl.

8. The composition of claim 6, wherein each R² is independently —(C₂₋₃)alkylene-O—(C₃₋₅)alkyl.

9. The composition of claim 6, wherein each R² is independently

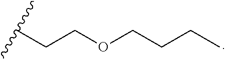 [SMILES: *CCOCCCC]

10. The composition of claim 1, wherein R¹ is acetyl.

11. The composition of claim 10, wherein each R² is independently —(C₂₋₃)alkylene-O—(C₁₋₆)alkyl.

12. The composition of claim 10, wherein each R² is independently —(C₂₋₃)alkylene-O—(C₃₋₅)alkyl.

13. The composition of claim 10, wherein each R² is independently

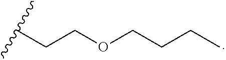 [SMILES: *CCOCCCC]

14. The composition of claim 1, wherein the plasticizer is

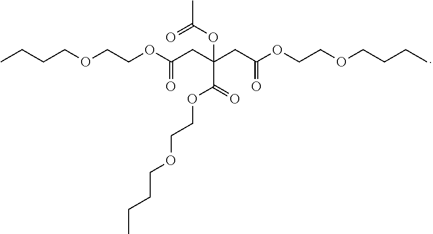 [SMILES: CCCCOCCOC(=O)CC(CC(=O)OCCOCCCC)(OC(C)=O)C(=O)OCCOCCCC]

15. The composition of claim 1, wherein the plasticizer is present from 35 to 55 phr relative to the sum total of the PVC polymer.

16. The composition of claim 1, wherein the composition further comprises a stabilizer which is a primary antioxidant.

17. The composition of claim 16, wherein the primary antioxidant is present from 0.05 to 0.3 phr relative to the sum total of the PVC polymer.

18. The composition of claim 16, wherein the primary antioxidant is a phenolic antioxidant.

19. The composition of claim 16, wherein the phenolic antioxidant is chosen from
(1) tris(4-tert-butyl-3-hydroxy-2,6-dimethylbenzyl) isocyanurate;
(2) 2,2′-methylenebis(4-methyl-6-tert-butylphenol);
(3) 2,2′-methylenebis(4-ethyl-6-tert-butylphenol);
(4) 1,3,5-trimethyl-2,4,6-tris(3,5-di-tert-butyl-4-hydroxybenzyl) benzene;
(5) 3,3′,3′,5,5′,5′-hexa-tert-butyl-a,a′,a′-(mesitylene-2,4,6-triyl)tri-p-cresol;
(6) ethylene bis(oxyethylene) bis-(3-(5-tert-butyl-4-hydroxy-m-tolyl)propionate);
(7) hexamethylene bis[3-(3,5-di-tert-butyl-4-hydroxyphenyl)propionate];
(8) pentaerythritol tetrakis(3-(3,5-di-tert-butyl-4-hydroxyphenyl)propionate);
(9) thiodiethylene bis[3-(3,5-di-tert-butyl-4-hydroxyphenyl)propionate];
(10) octadecyl 3-(3,5-di-tert-butyl-4-hydroxyphenyl)propionate;
(11) N,N′-1,6-hexanediylbis[3,5-bis(1,1-dimethylethyl)-4-hydroxy-benzenepropanamide;
(12) phosphonic acid, [[3,5-bis(1,1-dimethylethyl)-4-hydroxyphenyl]methyl]-, monoethyl ester, calcium salt (2:1);
(13) 1,3,5-tris(3,5-di-tert-butyl-4-hydroxybenzyl)-1,3,5-triazine-2,4,6(1H,3H,5H)-trione; or
(14) 1,1,3-tris(2-methyl-4-hydroxy-5-tert-butylphenyl)butane.

20. The composition of claim 16, wherein the phenolic antioxidant is 1,1,3-tris(2-methyl-4-hydroxy-5-tert-butyl phenyl) butane.

21. The composition of claim 1, further comprising other components chosen from a filler, a flame retardant, a stabilizer, a pigment, a processing aid, another plasticizer, or combinations.

22. The composition of claim 16, further comprising other components chosen from a filler, a flame retardant, a stabilizer, a pigment, a processing aid, another plasticizer, or combinations.

23. The composition of claim 1, wherein when the composition is molded into 0.762 mm thick die C cut specimen and exposed to a temperature of 136° C. for 168 hours, in an atmosphere of circulated air as tested according to UL 2556, has a tensile strength retention of at least 80%, as compared to that of an unexposed control of the same composition and shape, wherein the tensile strength is determined according to ASTM D 412 at a 500 mm/min pulling rate.

24. The composition of claim 1, wherein the composition has a dry time of less than 5 min as measured according to ASTM 2396-94.

25. The composition of claim 1, wherein when the composition is molded into 0.762 mm thick die C cut specimen and exposed to a temperature of 136° C. for 168 hours, in an atmosphere of circulated air as tested according to UL 2556, has an elongation at break retention of at least 70%, as compared to that of an unexposed control of the same composition and shape, wherein the elongation of break is determined according to ASTM D 412 at a 500 mm/min pulling rate.

26. The composition of claim 1, wherein the plasticizer of formula I has a viscosity of less than 60 centipoise as measured at 25° C. using an AR 2000 rotational rheometer using a 40 mm aluminum parallel plate.

27. The composition of claim 1, wherein, when the composition is formed into a sheet 1.9 mm thick sheet, cut into specimens measuring 12.7 by 25.4 mm, conditioned at 23° C. and 50% relative humidity for 24 hours, then tested for plasticizer compatibility according to ASTM D3291-11, the specimens exhibit an exudation grading of zero seven days.

28. An insulation layer formed from the composition of claim 1.

29. A cable comprising:
(1) a conductor;
(2) an insulation layer surrounding the conductor, the insulation layer formed from the composition of claim 1.
